(19) United States
(12) Patent Application Publication
(10) Pub. No.: US 2014/0377563 A1
(43) Pub. Date: Dec. 25, 2014

(54) MODIFIED-RUBBER COMPOSITE AND PROCESS FOR OBTAINING SAME

(71) Applicant: RUBIND INC., Road Town, Tortola (VG)

(72) Inventors: Jorge B. Sousa, Walnut Creek, CA (US); Andrey Vorobyev, Beer Sheva (IL)

(73) Assignee: RUBIND INC., Tortola (VG)

(21) Appl. No.: 14/383,424

(22) PCT Filed: Mar. 6, 2013
(86) PCT No.: PCT/IL2013/050201

§ 371 Date: Sep. 5, 2014

Related U.S. Application Data
(60) Provisional application No. 61/607,202, filed on Mar. 6, 2012.
(60) Provisional application No. 61/649,553, filed on May 21, 2012.
(60) Provisional application No. 61/733,620, filed on Dec. 5, 2012.

(51) Int. Cl. C08L 95/00

(52) U.S. Cl. CPC C08L 95/00; C08L 2555/80
USPC 428/403; 428/489; 428/402; 524/59; 524/8

(57) ABSTRACT

Provided is a rubber composite including rubber having an internal structure and an external surface, and a heavy-fraction oil distillate, where the heavy-fraction oil distillate is substantially contained within the internal structure, and the rubber external surface is substantially oil-free. Also provided are compositions containing the rubber composite, and processes for obtaining the rubber composite.

### TECHNOLOGICAL FIELD

This invention relates to a modified rubber composite for use in a variety of applications, and methods for its preparation.

### BACKGROUND

Bitumen is the heaviest fraction of the oil distillation process. Due to the different original raw materials (oils, tars, bituminous sands and so on) and different technologies of their distillation, bitumen may be used in a variety of applications. One of the main applications for bitumen is as a binder in asphalt mixtures where the bitumen is mixed with mineral aggregates of different sizes, shapes and chemical nature. These asphalt mixtures are particularly used for construction or maintenance of pavements, roads, different service roads and any other rolling surfaces.

Asphalt mixtures are used in applications exposed to a wide variation of environmental conditions. In this connection, the properties of the asphalt bitumen-based binders in high and low temperature conditions are of a decisive importance. At low temperatures, bituminous materials can become brittle, leading to fissures and cracks due to thermal stresses formed. At higher temperatures the viscosity of the bitumen binders becomes lower, potentially leading to rutting of roads. Resistance to fatigue and impact, and the adherence of bitumen binder to aggregate in asphalt mixtures, are also of particular importance for road construction.

The use of bitumen-based binders modified with polymers dates back to the 1970s, when those were formulated to improve the mechanical capabilities of the bituminous binder to withstand increasingly severe stresses caused by traffic. Usually, such modifications mainly seek to improve the elasticity and temperature sensitivity of the bituminous binder, leading to an increased resistance to fatigue, reduced permanent deformation and reduction in the propagation of cracks in the asphalt, either in road application or roofing applications.

The main polymer used, styrene-butadiene-styrene block-copolymer (SBS), helps to increase the softening point of the bituminous binder, thereby increasing flexibility and ductility at low temperatures, and allowing its use in a wider temperature range than conventional, non-modified, bitumen-based binders.

The use of rubber modified bitumen binders in hot asphalt began in the 1940s. In the United States, Charles H. MacDonald and other [1-5] have developed a highly elastic material to be used in the maintenance of pavements and roofing industry. This product was composed of bituminous binder and 18 to 24% ground tire rubber (having a particle size of 0.6 to 1.2 mm), mixed at around 180° C.-190° C. for about 45 minutes. The incorporation of granulated recycled tire rubber into bitumen aimed to improve the mechanical behavior of bituminous mixtures. Recently a few other advantages of this composition have been recognized, such as decreased environmental pollution, reduction of CO₂ emissions, better friction in roads, etc. The modification allowed the bitumen to have greater flexibility and hold stable for much longer periods of time compared to conventional bitumen, resulting in a lower rate of aging.

U.S. Pat. No. 6,346,561 [6] describes a method of combining crumb rubber with gilsonite or tall oil, both of which are light fraction distillates of oil, in the presence of fatty acids, with curative elastomers to form a liquid concentrate to be added to asphalt compositions.

### REFERENCES

[1] U.S. Pat. No. 4,118,137
[2] U.S. Pat. No. 4,166,049
[3] U.S. Pat. No. 4,180,730
[4] U.S. Pat. No. 4,021,393
[5] U.S. Pat. No. 4,069,182
[6] U.S. Pat. No. 6,346,561

### GENERAL DESCRIPTION

The present invention relates to a rubber composite comprising rubber and a heavy-fraction oil distillate.

The “rubber” may be a natural rubber (i.e. caoutchouc) or a synthetic rubber. The rubber has an “internal structure”, being characterized by open cellular structure containing pores that are connected to one another and form an interconnected network; and an “external surface”, being the outmost surface of the rubber particles.

The term “heavy fraction oil distillates” refers to oily carbonaceous products, usually obtained by distillation, refining or fractionation processes of crude oil from different origins such as oil wells, oil sands, fossil fuel, etc. Such fractions typically comprise hydrocarbons and other organic compounds containing nitrogen, sulfur and/or oxygen atoms, and are operatively soluble in various organic solvents, including straight chain hydrocarbon solvents, such as pentane or hexane, at a temperature lower than 40° C. Such heavy-fractions may be, for example, bitumen and asphaltenes.

In one of its aspects, the invention provides rubber composite comprising rubber and a heavy-fraction oil distillate, said rubber having an internal structure and an external surface, wherein said heavy-fraction oil distillate is substantially contained within the internal structure, and wherein the rubber's external surface is substantially oil-dry or oil-free.

The term “composite” is used to denote a composition of matter of the invention, composing at least two components (i.e. rubber and bitumen). Such a rubber composite may be also referred to as “reacted rubber”. Therefore, the invention provides a rubber-based composite, in which the heavy-fraction oil distillate is “substantially” contained within the internal structure of the rubber. Namely at least 99.5% of the oil is contained within the rubber, while the rubber's external surface is substantially oil-dry (oil-free). In some embodiments, 99.6, 99.7, 99.8, 99.9% of the oil is contained within the rubber. In other embodiments, the heavy-fraction oil distillate is completely contained within the internal structure of the rubber, namely no oil exits on the external surface of the rubber. The term “oil-dry” or “oil-free” thus stands to mean that the external surface, namely the out-most layer of the rubber, is substantially, or completely, free of the heavy fraction oil.

It should be noted that while the oil is substantially contained within the internal structure, the pores of said structure need not be fully packed.

In some embodiments, the heavy-fraction oil distillate is bitumen.

In other embodiments, the rubber is in the form of particles (“particulate”). In some embodiments, the rubber is “vulcanized”, i.e. cross-linked, or sulfur-cured rubber. In some embodiments, the rubber is a particulate vulcanized rubber.

The rubber composite of the invention may be of any shape selected from a particle, a flake, a sheet, a crumb, a grain, a pellet, a granule, etc. In some embodiments, the composite is in a form of particles. In other embodiments, the composition is in a form of pellets. The term “particle size” typically refers to the average diameter of the particles. When the particles are of non-spheroid shape, the term refers to the average equivalent diameter of the particle, namely the diameter of an equivalent spherical particle based on the longest dimension of the particle.

According to some embodiment, the composite of the invention comprises at least 15% wt of heavy-fraction oil distillate. In other embodiments, the composite comprises between about 15% wt and 30% wt heavy-fraction oil distillate. In some other embodiments, the composite comprises between about 15% wt and 28% wt, between about 15% wt and 25% wt, between about 15% wt and 23% wt, between about 15% wt and 20% wt, or between about 15% wt and 18% wt of heavy-fraction oil distillate. In further embodiments, the composite comprises between about 18% wt and 30% wt, between about 20% wt and 30% wt, between about 23% wt and 30% wt, between about 25% wt and 30% wt, or between about 28% wt and 30% wt of heavy-fraction oil distillate.

In other embodiments, the rubber composite may further comprise at least one additive. The additive may be in a liquid form or a solid form, and in some embodiments is a powdered solid. The additive may be used, in accordance with the invention, to activate the rubber-composite, thereby forming a “reacted and activated rubber”, (referred to also as “RAR” for the sake of abbreviation). Such activation may be an “internal activation”, namely within the rubber composite, or an “external activation”, activating the rubber's external surface. The activation further modifies the properties of the rubber composite in order to obtain different properties, such as improved mixing capability in other carriers (such as binders and asphalt), improved thermal stability, prolonged storage stability, etc.

Therefore, in some embodiments, the at least one additive is contained within the internal structure of the rubber composite, while in other embodiments, the at least one additive is present at the external surface of the rubber composite.

According to some embodiments, the at least one additive is both contained within the internal structure of the rubber composite and present at the external surface of the rubber composite.

The at least one additive may be a mineral-based powder, selected in a non-limiting fashion from silica (silicon dioxide), surface-activated silica, mica, porcelanite, other silica or amorphous silica containing materials, lime, cement, and other additives known in the art.

In some embodiments, the at least one additive is silica, which may be amorphous or crystalline.

In some embodiments, the at least one additive is porcelanite.

As known in the art, “porcelanite” is activated natural silica mineral, having active groups on its surface, such as quaternary ammonium groups.

In some embodiments, the rubber composite comprises at least 1% wt of said at least one additive. In other embodiments, the additive content within the rubber composite is between about 1% wt and 30% wt. In some other embodiments, the additive content within the rubber composite may be between about 1% wt and 25% wt, between about 1% wt and 20% wt, between about 1% wt and 15% wt, between about 1% wt and 10% wt, between about 1% wt and 7% wt, between about 1% wt and 5% wt, or between about 1% wt and 3% wt. In further embodiments, the additive content within the rubber composite may be between about 3% wt and 30% wt, between about 5% wt and 30% wt, between about 7% wt and 30% wt, between about 10% wt and 30% wt, between about 15% wt and 30% wt, between about 20% wt and 30% wt, or between about 25% wt and 30% wt.

In another aspect, the invention provides a rubber composite particle comprising vulcanized rubber, a heavy-fraction oil distillate and at least one powdered additive, said rubber having an internal structure and an external surface, wherein said heavy-fraction oil distillate is substantially contained within the internal structure, and wherein the rubber's external surface is substantially oil-free.

In some embodiments, the heavy-fraction oil distillate is completely contained within the internal structure of the rubber.

In further embodiments, the rubber composite particle comprises at least 15% wt of heavy-fraction oil distillate. In such embodiments, the particle may comprise between about 15% wt and 30% wt heavy-fraction oil distillate.

According to some embodiments, the at least one additive is contained within the internal structure of the rubber composite.

According to other embodiments, the at least one additive is present at the external surface of the rubber composite.

According to some other embodiments, the at least one additive is both contained within the internal structure of the rubber composite and at the external surface of the rubber composite.

In some embodiments, said at least one powdered additive is a mineral-based powder selected in a non-limiting fashion from silica, surface-activated silica, mica, porcelanite, other silica or amorphous silica containing materials, lime, cement, and others.

In other embodiments, the rubber composite particle comprises at least 1% wt of said at least one additive. In such embodiments, the particle may comprise between about 1% wt and 30% wt of said at least one additive.

Another aspect of the invention provides a composition comprising:
rubber composite particulate matter, said composite comprising rubber and a heavy-fraction oil distillate, said rubber having an internal structure and an external surface, wherein said heavy-fraction oil distillate is substantially contained within the internal structure, and wherein the rubber's external surface is substantially oil-free;
paving binder; and
aggregate;

wherein said composition is characterised by dimensional regaining of at least 10% within 24 hours after unloading under Marshall test conditions.

The “Marshal test” is a standard test for paving composition (see, for example, ASTM-D-1559), directed at evaluation of the resistance of the pacing composition to plastic deformation under compression loading. The compositions of the invention show a certain degree of return to the sample's original dimensions once the load is removed from the sample (i.e. “dimensional regaining”).

In a further aspect of the invention, there is provided a process for obtaining a modified rubber composite, the process comprising:
(a) providing particulate rubber;
(b) providing a heavy-fraction oil distillate, wherein said heavy-fraction oil distillate optionally comprises at least one additive; and
(c) mixing the rubber and heavy-fraction oil distillate under conditions permitting a reaction to develop exothermally, to thereby obtain a modified rubber composite in which the heavy-fraction oil distillate in substantially contained within an internal structure of the rubber.

The term “modified rubber composite” (interchangeably referred to as rubber composite) denotes a composite comprising rubber and at least one more material incorporated into or onto the rubber in order to modify, i.e. change, its various properties. According to the invention, such modification may be achieved by absorbing the heavy-fraction oil distillate into the rubber. Further modification of properties may be achieved by using different additives, mostly mineral-based powders, which may be incorporated into the composite (namely into the internal structure of the rubber) or by introduction of said additives onto the surface of the composite.

In some embodiments, the heavy-fraction oil distillate is completely contained within the internal structure of the rubber.

In other embodiments, the particulate rubber is particulate vulcanized rubber.

The step of mixing is conducted “under conditions permitting a reaction to develop exothermally”, meaning the mixing is performed under such conditions that an exothermic reaction is developed, which, without wishing to be bound by theory, assists to essentially completely absorb the heavy-fraction oil distillate into the rubber, thereby resulting in the internally-activated composite. Such conditions may be, for example, elevated temperature and/or pressure.

In some embodiments, said conditions include mixing at a temperature of between about 120° C. and 260° C. In other embodiments, said mixing is carried out at a temperature of between 160° C. and 210° C. In some other embodiments, the mixing may be carried out at a temperature selected from 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., or 210° C.

In some other embodiments, said mixing is carried out for a period of time of at least 10 seconds. According to such embodiments, said mixing may be carried out for a period of time of between 10 seconds and 10 minutes. According to other embodiments, said mixing is carried out for a period of time of between 30 seconds and 7 minutes. According to some other embodiments, said mixing is carried out for a period of time of between 1 minutes and 5 minutes.

In some embodiments, the process further comprises a step of grinding said modified rubber composite to reduce the particles to a desired size. It is appreciated that grinding may be carried out by any means known to a person of skill in the art.

Thus, the process of the invention may comprise:
(a) providing particulate rubber;
(b) providing a heavy-fraction oil distillate, wherein said heavy-fraction oil distillate optionally comprises at least one additive;
(c) mixing the rubber and heavy-fraction oil distillate under conditions permitting a reaction to develop exothermally, to thereby obtain a modified rubber composite in which the heavy-fraction oil distillate in substantially contained within an internal structure of the rubber; and
(d) grinding said modified rubber composite to reduce the particles to a desired size.

In further embodiments, the process further comprises a step of adding at least one additive. According to some embodiments, said step of adding at least one additive is carried out simultaneously with or subsequently to step (c). According to other embodiments, said step is carried out simultaneously with or subsequently to step (d).

In some embodiments, when the heavy-fraction oil distillate comprises at least one additive, the additive may be pre-mixed into the heavy-fraction oil distillate at a temperature of between about 120° C. to 180° C. In other embodiments, additive may be pre-mixed into the heavy-fraction oil distillate at a temperature selected from 120° C., 125° C., 130° C., 135° C., 140° C., 145° C., 150° C., 155° C., 160° C., 165° C., 170° C., 175° C., or 180° C.

In some other embodiments, the heavy-fraction oil distillate is bitumen.

In other embodiments, the modified rubber composite comprises at least 15% wt of heavy-fraction oil distillate. In such embodiments, the modified rubber composite may comprise between about 15% wt and 30% wt heavy-fraction oil distillate.

In some embodiments, said at least one additive is a mineral-based powder selected from silica, surface-activated silica, mica, porcelanite, other silica or amorphous silica containing materials, lime, cement, or others known in the art.

In other embodiments, said additive is present in the particulate dry modified rubber composite in an amount of at least 1% wt. In such embodiments, the particulate dry modified rubber composite comprises between about 1% wt and 30% wt of said at least one additive. In other embodiments, up to 25% wt of said additive is contained within the heavy-fraction oil distillate.

According to some embodiments, the particulate rubber of step (a) and the heavy-fraction oil distillate of step (b) are provided in a mixture.

In another aspect, the invention provides a particulate modified rubber composite obtainable by the process as described herein.

In a further aspect, the invention provides for a particulate modified rubber composite obtained by the process as described herein.

The rubber composite of the invention may be used for encapsulation of bitumen, thereby forming particulate matter which surface is substantially oil-free and, thus, stable for storage and transport for prolonged periods of time. Such encapsulation affords for a composition which comprises both the rubber composite and a bituminous component, thereby eliminating (or at least minimizing) the need to form a bitumen-composite mix on-site prior to utilization.

Thus, in another aspect, the invention provides a composition comprising a bitumen core, and an encapsulation layer comprising the rubber composite as herein described. The rubber composite at least partially coats, i.e. encapsulates, a bitumen core, thereby obtaining a composition which external surface is substantially oil-free.

In some embodiments, the rubber composite substantially fully encapsulates the bitumen core.

In order to further stabilize the composition, an additional coating layer may be provided, rendering the composition stable at elevated temperatures (up to circa 40° C.). Such an additional coating layer renders the composition stable for at least 24 hours at 30° C.

Therefore, in some embodiments, the composition further comprises a coating layer of at least one powdered additive, the layer at least partially coating the external surface of the composition. In such embodiments, the at least one additive is a mineral-based powder, which may be selected from silica, surface-activated silica, mica, porcelanite, other silica or amorphous silica containing materials, lime and cement.

In additional embodiments, the at least one powdered additive is porcelanite.

In some embodiments, the composition is in the form selected from a particle, a flake, a sheet, a crumb, a grain, a pellet and a granule. In additional embodiments, the composition is in the form a pellet.

In some other embodiments, the pellet has an average diameter of between 1 and 20 mm.

As a person of the art may appreciate, as the encapsulating rubber composite in itself comprises bitumen and optionally a powdered additive, the layers in the composition may be fused to some extent, creating mixed interfaces between the layers.

In another aspect, the invention provides a pellet comprising:
a bitumen core;
an encapsulation layer comprising the rubber composite as described herein, said encapsulation layer at least partially encapsulates the bitumen core; and
a coating layer comprising at least one powdered additive, said coating layer at least partially coats said encapsulation layer,

wherein the pellet's external surface is substantially oil-free.

In some embodiments, the rubber composite substantially fully encapsulates the bitumen core.

In other embodiments, the at least one additive is a mineral-based powder selected from silica, surface-activated silica, mica, porcelanite, other silica or amorphous silica containing materials, lime and cement.

In further embodiments, the pellet has an average diameter of between 1 and 20 mm.

Another aspect of the invention provides a process for obtaining a pelletized composition, the process comprising the steps of:
(i) providing a plurality of pellet cores, each pellet core consisting of bitumen; and
(ii) at least partially encapsulating each of said cores by the rubber composite of any one of claims 1 to 26, thereby obtaining a pellet having a substantially oil-free surface.

In some embodiments, said plurality of pellet cores are obtained by heating bitumen to form a bitumen melt, and atomizing said bitumen melt. The term “bitumen melt” relates to bitumen in a liquid state. In cases amorphous bitumen is used, the term refers to liquid bitumen having a reduced viscosity, enabling easier flow of the bitumen.

In some embodiments, said bitumen is heated to a temperature of between 150° C. and 220° C. In other embodiments, the bitumen is heated to a temperature of between about 170° C. and 200° C. In additional embodiments, the bitumen may be heated to a temperature selected from 150° C., 155° C., 160° C., 165° C., 170° C., 175° C., 180° C., 185° C., 190° C., 195° C., 200° C., 205° C. or 210° C.

The step of “atomizing” usually refers to pressure-feeding the bitumen melt through a nozzle having an orifice with a desired diameter, resulting in bitumen droplets. The bitumen droplets are allowed to solidify at room temperature, thereby obtaining the bitumen cores. Solidification may be also carried out by passing the bitumen droplets through cold-air tunnels or through a counter-flow of air.

In some embodiments, the pellet cores have an average diameter of between 1 and 10 mm.

In order to facilitate packaging and adherence of the rubber composite on the surface of the bitumen cores, the rubber composite may be grinded prior to utilization. Therefore, in some embodiments, the rubber composite is in powder form.

In such embodiments, the rubber composite powder may have an average particle size of 0.5 to 5 mm.

In some additional embodiments, the rubber composite substantially fully encapsulates each of said cores.

Encapsulation of the cores by the rubber composite is carried out by mixing the rubber composite with the bitumen cores, typically in a tumble-drum, although other methods such as dry-spraying or powdering may also be utilized.

According to some embodiments, the process further comprises a step (iii) of at least partially coating said surface with at least one powdered additive. In such embodiments, the at least one additive is a mineral-based powder selected from silica, surface-activated silica, mica, porcelanite, other silica or amorphous silica containing materials, lime and cement.

In some embodiments, the at least one powdered additive is porcelanite.

In another aspect, the invention provides a pelletized composition obtainable by the process as described herein.

In a further aspect, the invention provides for a pelletized composition obtained by the process as described herein.

According to another aspect, there is provided a rubber-based product comprising of or being the rubber composite or the rubber composite particle as described herein. The term “rubber-based product” relates to a product containing the rubber composite, —the rubber composite particle, the composition or the pellet of the invention, wherein at least 0.5% of the total weight of the product is a modified rubber according to the invention. Therefore, according to some embodiments, the product comprises at least 1% wt of the rubber composite, the rubber composite particle the composition or the pellet as described herein.

Such products may, for example, be a paving product, a roofing product, a paint additive, a hydro isolation composition additive, a caoutchouc additive, etc.

In some embodiments, the rubber based product is characterised by dimensional regaining of at least 10% within 24 hours after unloading under Marshall Test conditions.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 is a schematic representation of an exemplary RAR usage during the preparation of a paving mixture.

FIG. 2 shows the change in viscosity during mixing of RAR with bitumen binder.

FIG. 3 shows the dependency of resilience on the reaction temperature of a RAR-composite of the invention.

FIGS. 4A-4B show Marshall Test results for different compositions: average strength (FIG. 4A) and deformation (FIG. 4B).

FIG. 5 shows the outline of deformation measurement in a Marshall test of a paving composition comprising the rubber-composite of the invention.

FIGS. 6A-6B show wheel tracking test results for different compositions: average deformation speed (FIG. 6A); and deformation (rutting) (FIG. 6B).

FIG. 7 shows deformation test results of different compositions.

FIG. 8 shows results of ITS water damage resistance test.

FIG. 9 demonstrates Cantabro test results of different compositions.

FIGS. 10A-10D show respectively, the softening point as a function of the penetration (FIGS. 10A and 10B), penetration as a function of resilience (FIG. 10C), and resilience as a function of softening point of different compositions (FIG. 10D); wherein activation process III; ▪ activation process O; □ activation process IV, 10% coverage; [symbol] activation process IV, 20% coverage; [symbol] activation process IV, 30% coverage.

FIG. 11 shows fatigue test results of different compositions (▪ SMA-0.4% SiO₂; [symbol] SMA-0.4% Fibers; Comp-3; ◯ Comp-4).

FIG. 12 shows the elasticity modulus as a function of the strain amplitude of different compositions as calculated from the results of the fatigue test (▪ Comp-3; [symbol] Comp-4).

FIGS. 13A-13B show the PG grading of paving compositions comprising different concentrations of RAR composite: high temperature grading (FIG. 13A) and low temperature grading (FIG. 13B).

### DETAILED DESCRIPTION OF EMBODIMENTS

In the present invention, the modified-rubber composite may be used in asphalt mixtures, thereby providing the following technological and operational advantages, as compared to standard existing asphalt mixtures:
better mechanical stability under low and high usage temperatures;
improved rutting resistance and fatigue resistance;
improved wearing resistance;
improved resistance to water damage;
“self-healing” properties—asphalt mixtures comprising the modified-rubber composite show mechanical recovery, as well as recovery of geometrical form and dimensions after unloading.

When used as the additive to paints, as compared to standard paints the composite provides for:
better adhesion to metals;
better corrosion protection properties;
higher mechanical strength;
“self-healing” properties—the ability of the paint to self-recover scratches;

When used as an additive to hydro isolation materials (such as mastics) as compared to such standard materials, the composite provides for:
better adhesion to concrete;
lower heat conductivity;
higher corrosion resistance;
better noise isolation properties;
higher vapour permeability.

When used as an additive to roofing materials, as compared to such standard materials, the composite provides for:
higher corrosion resistance;
lower heat conductivity;
prevention of icing formation.

When added to caoutchouc, the composite provides for preserving of the natural caoutchouc properties, even if up to 5-70% of the natural caoutchouc is exchanged for the composite of the invention.

The modified rubber composite of the invention is a product that is comprises rubber, usually in particulate form, and a certain percentage of heavy-fraction oil distillate (typically bitumen). In some cases, the composite further comprises additives, mineral-based, such as silica, the natural activated mineral porcelanite (AP), lime, cement and others. In the basic concept, the percentage of bitumen (or organic oil) used in the preparation of the modified rubber composite (sometimes to be addressed as Reacted and Activated Rubber, or RAR), is exactly sufficient to be absorbed by the rubber, meaning that the rubber will not absorb any more bitumen over time, resulting in a dry particulate composite. The bitumen can also be used as a carrier of the additive (in some cases), promoting internal and/or surface activation of the rubber.

The composites of the invention are oil-free, namely the heavy-fraction oil distillate is substantially, preferably completely, absorbed within the rubber; namely, the surface of the rubber is essentially devoid of oil. As such, the rubber composite may be directly employed in further processing, such as plug mills, without the need of a drying process. Taking into consideration the fact that hot bitumen and hot aggregates are still needed and that the weight percentages of RAR used in a paving mix are typically of the order of 1 to 5% wt, there is no need to preheat the composite before feeding it into the plug mill. If desired, the composite of the invention can be coated with other products to lower the mixing and compaction temperatures of the final product in the field.

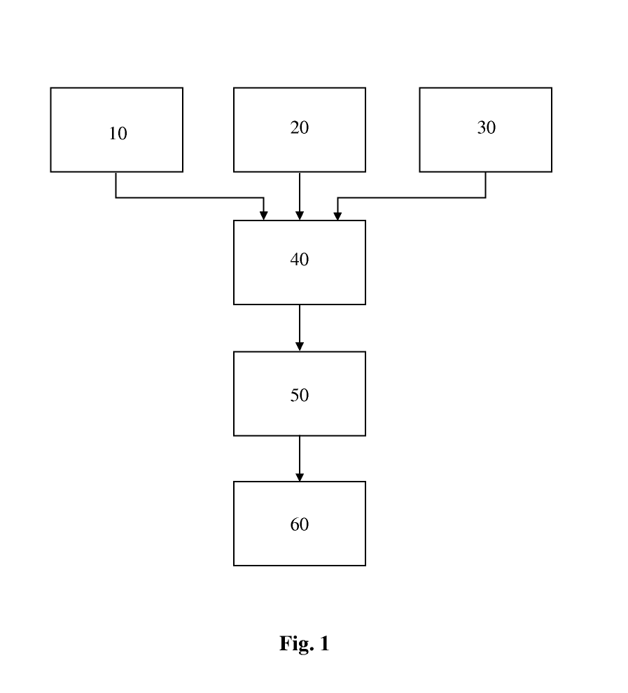

Referring to FIG. 1, a schematic, non-limiting, block diagram of an exemplary RAR usage during the preparation process of a paving mixture is presented. In such a process, reacted and activated rubber particulate matter of the invention (10) is mixed in a mixer (40), such as a dryer drum-mixer, with bitumen binder (20) and aggregate (30) to form the paving mixture. The mixture is further processed in a plug mill (50) and used on-site or stored in storage silos (60). A mix product prepared in such fashion has the advantage of highly improved dispersion and blending ability of the rubber particles into the bitumen paving binder, resulting from the activation and pre-reaction process of the rubber. Depending on the percentage of RAR in the paving binder, usually bitumen, the type of binder and gradation, this process can be used to prepare mixtures having improved (or at least comparable) properties as other known composition, such as SMA (Stone-Mastic Asphalt), Asphalt Rubber or Polymer modified mixes.

RAR may be easily transported and used in a variety of applications, and is stable under various storage conditions. As it is granulated (i.e. of particulate form), it can be stored in bags or in storage silos, and added to the asphalt mixes during the standard procedure of their preparation on site; for example, together with the aggregates at the concentration of 1 to 6% of the mass of the resultant asphalt mixes. RAR can also be used as an additive to different building and finishing materials, such as paints, including paints for metals, mastics, hydro isolation materials, roofing materials, and caoutchouc.

When added to caoutchouc, the composition provides for preserving of the natural caoutchouc properties, even if up to 5-70% of the natural caoutchouc is exchanged for the composition.

Laboratory Results:

A number of tests and experiments have been performed. All tests were conducted in strict accordance with International, European and national standards and methods acceptable in the paving industry. Exemplary results are provided below.

### 1. Rubber-Composite Properties

Several tests were conducted to demonstrate the unique behavior of the rubber-composites according to the invention. RAR particulate matter was mixed with bitumen binder according to the compositions and conditions provided in Table 1.

TABLE 1
rubber-composites of the invention used for testing

| | | % bitumen | Type of | Activation |
|---|---|---|---|---|
| Composition | %RAR | binder | activation | process |
| Comp-1 | 33.5 | 66.5 | I | A |
| Comp-2 | 33.5 | 66.5 | I | B |
| Comp-3 | 33.5 | 66.5 | I | O |
| Comp-4 | 33.5 | 66.5 | II | O |
| Comp-5 | 41 | 59 | I | O |
| Comp-6 | 41 | 59 | II | O |
| Comp-7 | 41 | 59 | I | A |
| Comp-8 | 41 | 59 | I | B |
| Comp-9 | 49 | 51 | I | O |

The type of activation refers to the addition of the mineral-based additive, in this case silicon oxide (silica, SiO₂). “I” denotes a total amount of 16% wt of silica-based additive, part of which is mixed with the bitumen prior to reaction with the rubber, and the remainder is added as a coating layer after reaction and internal activation of the rubber. “II” denotes a total amount of 5% wt of silica-based additive, only added as a coating later after reaction of the rubber with the bitumen. “III” will denote a total amount of 10% wt of lime-based additive, only added as a coating later after reaction of the rubber with the bitumen.

In all tested compositions, bitumen 35/50 pen was used as a binder to be mixed with the RAR, and later on with aggregate, to form the paving compositions.

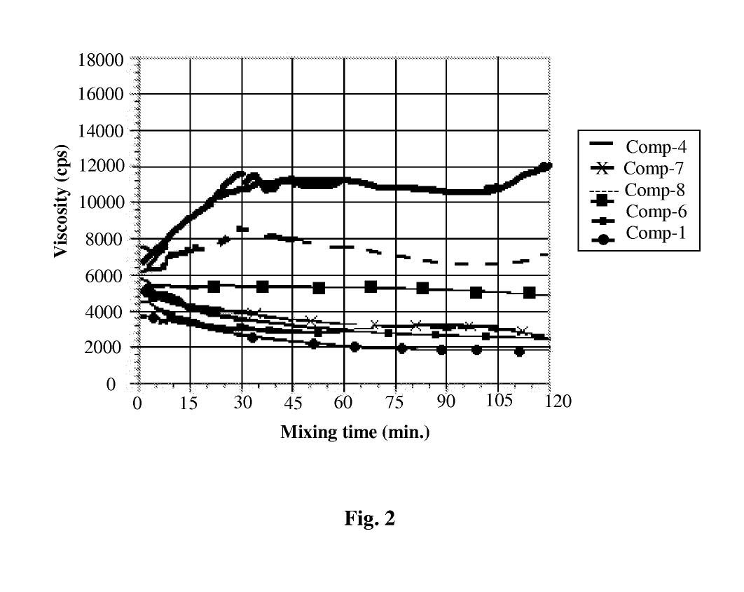

Viscosity test were carried out on RAR-bitumen mixtures using a Brookfield viscometer at 135° C. at 20 rpm, using a cylindrical spindle (according to testing method ASTM D 4402). As can be seen from FIG. 2, the viscosity (in cPs, or centipoises) of binder mixtures comprising the rubber-composite of the invention can be maintained at relatively constant values throughout the mixing process, facilitating the blending and homogenization of the composition. Such control of the viscosity of the binder prevents “drain-down” phenomena, which often occur when using standard SMA graded mixes. As demonstrated in FIG. 2, different levels of viscosity can be reached to satisfy several standard mixing requirements, by tailoring the rubber-composite/bitumen-binder ratio and the activation process of the rubber-composite.

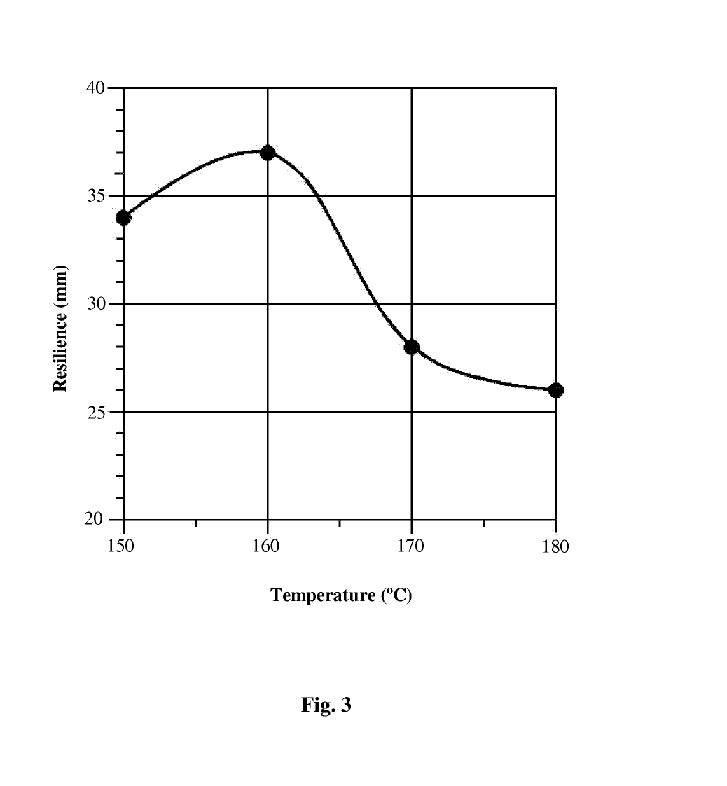

From further results it appears that for some RAR-composites there seems to be an optimal resilience achieved by carefully controlling the reaction temperature during the bitumen absorption process into the rubber particles. In the example results shown in FIG. 3, a reaction temperature of 160° C. resulted in an optimal resilience value. However, different RAR compositions falling within the scope of the present invention may show other optimal processing conditions, all encompassed in the scope of the present invention.

### 2. Mechanical Durability

### 2.1 Marshall Test Results

The Marshal test is a standard test for paving composition (see, for example, ASTM-D-1559), directed at evaluation of the resistance of the paving composition to plastic deformation under compression loading. A cylindrical specimen of the paving composition is loaded circumferentially at a constant deformation rate, typically at 50 mm/min. The maximal load carried by the specimen is measured at a standard test temperature of 60° C., along with a measurement of the deformation formed in the specimen until maximal load is reached, to obtain the so-called “Marshall stability” and “Marshall flow” values, respectively.

Marshal tests were carried out on different paving compositions comprising either RAR composite, SMA with silicon oxide additive, or SMA containing standard cellulose fibers.

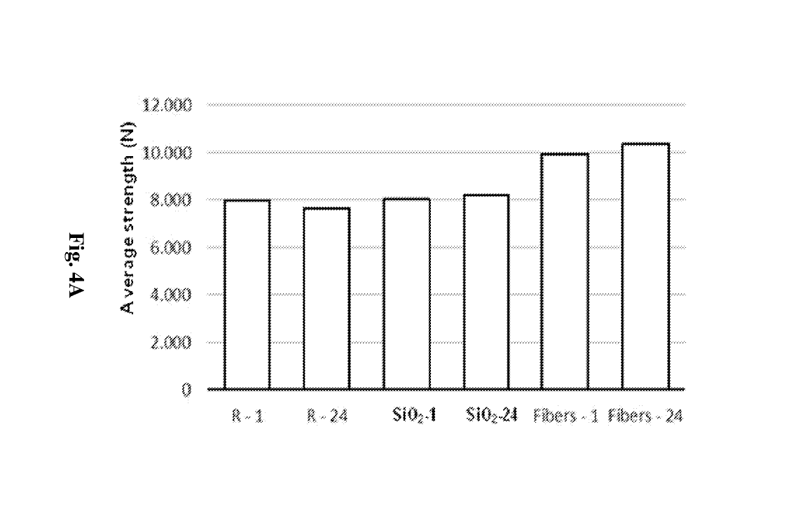

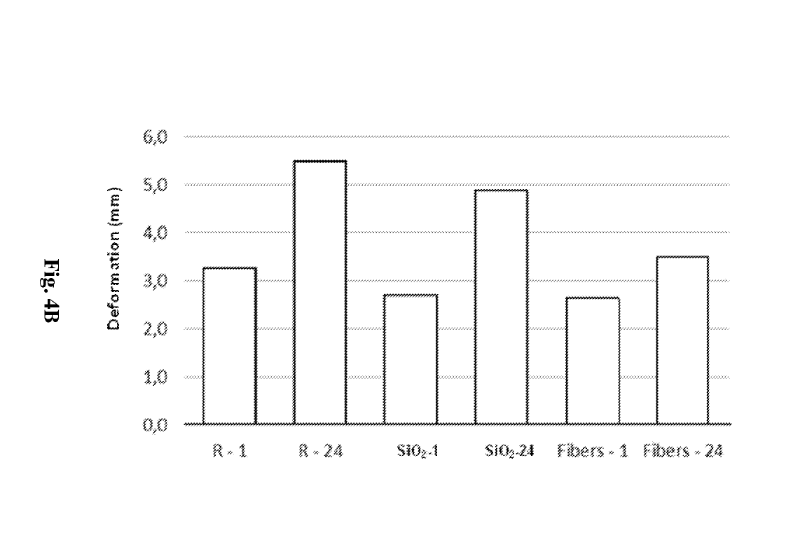

Test results are presented in Table 2 and FIGS. 4A-4B, relating to Marshall tests conducted for a duration of either 1 hour or 24 hours of load. As is evident from the results, when compared to standard paving composition comprising SMA with either silica or fibers, the paving compositions comprising the RAR composite showed higher deformation prior to cracking of the specimen, accompanied by lower average loads, indicating such paving compositions to be more ductile than those containing SMA in standard use. Such ductility suggests improved mechanical shock absorbance.

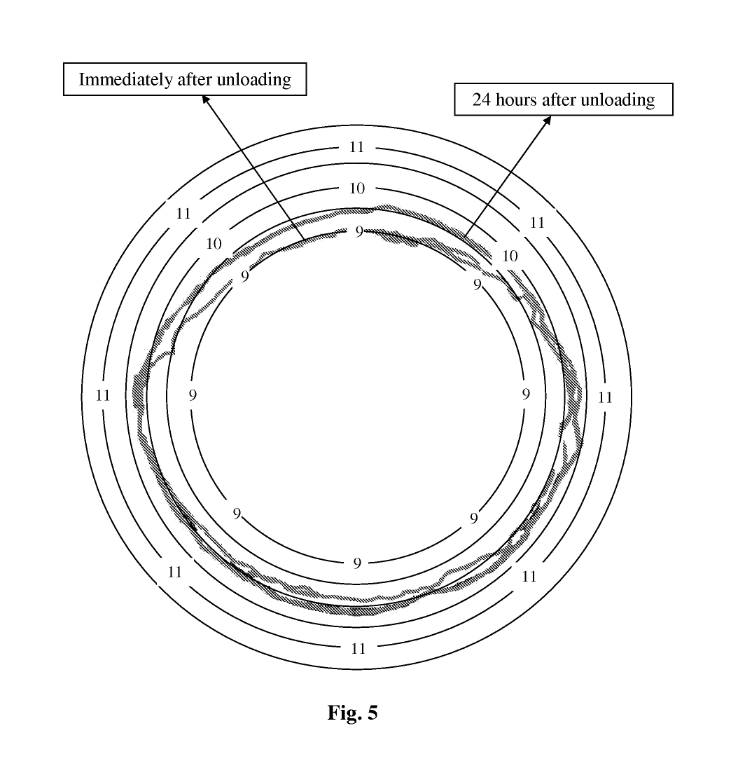

FIG. 5 demonstrates another advantage of the present invention: the figure shows an outline of the deformation measured for a specimen loaded according to the Marshall test conditions performed until cracking of the specimen. The deformation was measured immediately after unloading and 24 hours after unloading. The specimen contained RAR. Surprisingly, it was found that after 24 hours, the majority of the micro-cracks formed were unnoticeable, while the specimen regained its original dimensions to some extent. Remarkable dimensional recovery values of up to 33% after 24 hours were measured. Such test results may indicate the ability of paving compositions comprising RAR to self-heal in an extremely short period of time after unloading, suggesting the possibility to improve maintenance of paved surfaces. Without wishing to be bound by theory, such self-healing capability may be a result of the formation of a complex molecular network formed between the rubber and bitumen coating the aggregate particles, enabling the paving composition to elastically deform, rather than plastically, resulting in dimensional regaining after the load has been removed from the specimen.

### 2.2 Wheel Tracking Test Results

Rutting resistance of paving compositions containing the RAR composition and bitumen binder were tested using the wheel tracking test method (American Association of State Highway and Transportation Officials (AASHTO) standard T 324). The test is carried out by evaluating the damage observed during rolling of a steel wheel across the surface of a paving composition specimen, usually a slab that is immersed in water, either at room temperature or at 60° C. The slab typically has a length of 320 mm, a width of 260 mm, and a thickness of either 40, 80, or 120 mm. The thickness of the slab should be a minimum of three times the nominal maximum aggregate size. The test is carried out at different linear velocities and is stopped when reaching 20,000 wheel passings. Rutting, i.e. permanent deformation, was evaluated at room temperature after 120 minutes and at the end of the test, while rutting at 60° C. was measured after 24 and 37 hours.

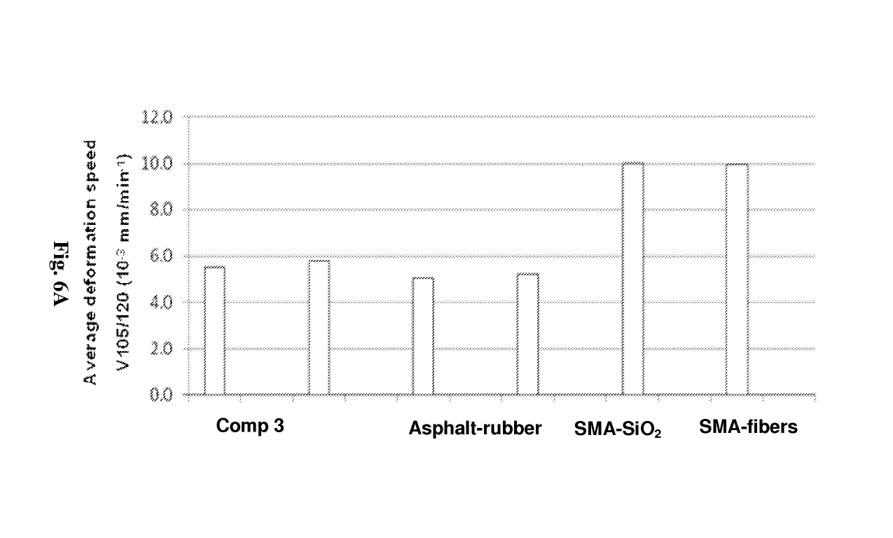

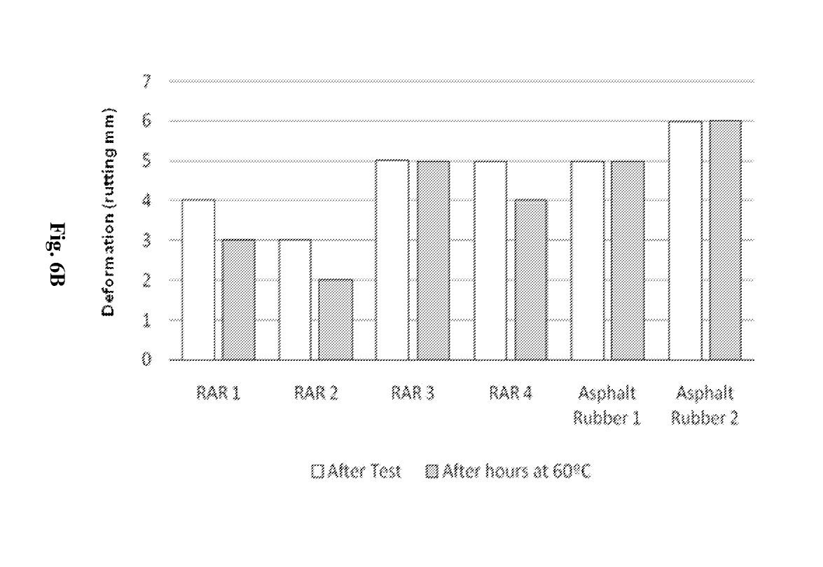

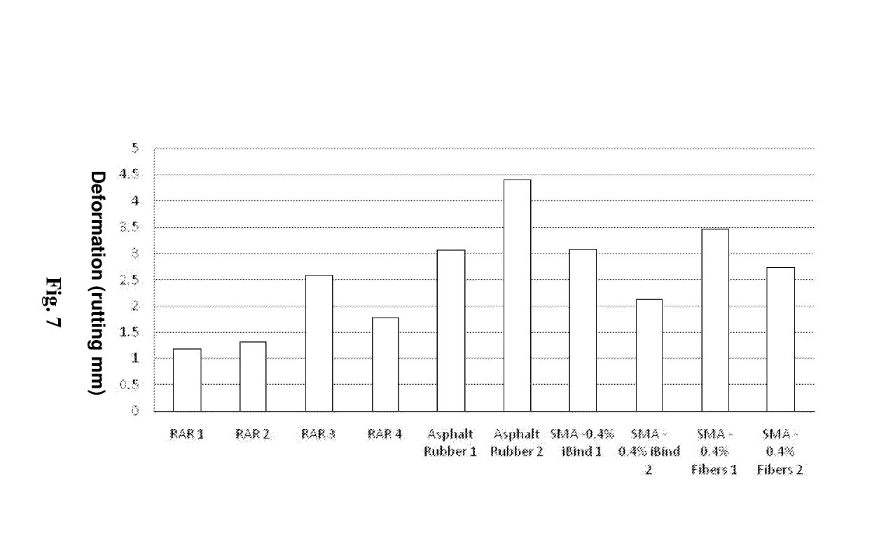

As is evident from the results shown on Table 3 and FIGS. 6A-6B and 7, paving compositions comprising the RAR composite of the invention demonstrate superior rutting results, i.e. significantly lower deformation of the specimens. In addition, self-healing was observed for the specimens containing RAR composite, while no such phenomenon was noticed for standard compositions in the industry.

### 3. Environmental Tests

### 3.1 ITS and Cantabro Test Results

Degradation of asphalt pavement is often accelerated by environmental conditions such as extreme temperatures and water damage. The presence of water (or high levels of moisture) has long been considered to have a significant effect on the mechanical integrity of the pavement, as premature failure is expected to occur as a result from the debonding of the binder film from the aggregate' surface. In addition, water damages also include loss of cohesion of binder system, as well as degradation in the aggregate mechanical properties.

The ITS (indirect tensile strength) test is designed to evaluate the degradation of mechanical properties of paving composition specimens as a result of exposure to moisture (AASHTO standard T-283). The tensile strength of paving specimens is measured after conditioning at room temperature, and then compared to the tensile strength measured after immersion of the specimens in hot water for a predetermined period of time. The TSR value (tensile strength ratio) is indicative to the pavement susceptibility to moisture, i.e. higher TSR values are associated with higher resistance to water damage.

The Cantabro test (such as that described in Australian standard testing (AST) 07) is designed to evaluate the ability of the paving composition to maintain its cohesive integrity when exposed to continuous mechanical shock. Cylindrical specimens of the paving composition are subjected to continuous mechanical impact at a controlled environment by tumbling the specimens in a rotating drum for a defined period of time. Specimens are either conditioned at room temperature or at a hot water bath for a predetermined time period. Weight loss is measured as a result of the tumbling action.

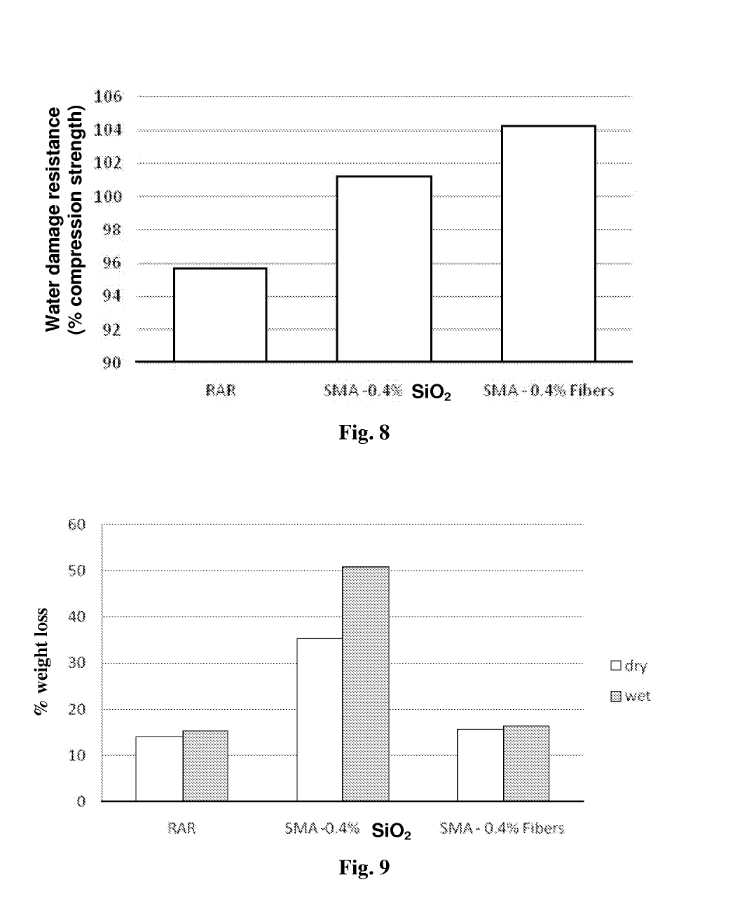

As seen in Table 4 and FIGS. 8-9, paving compositions comprising the RAR composite demonstrate higher cohesive integrity both at dry and wet conditions, as well as higher TSR values. This suggests a significant improvement in binding of the RAR composite/bitumen mixture to the aggregate, decreasing the pavement's susceptibility to water damage.

### 3.2 Change in Properties of Paving Compositions as a Function of RAR-Composite Content

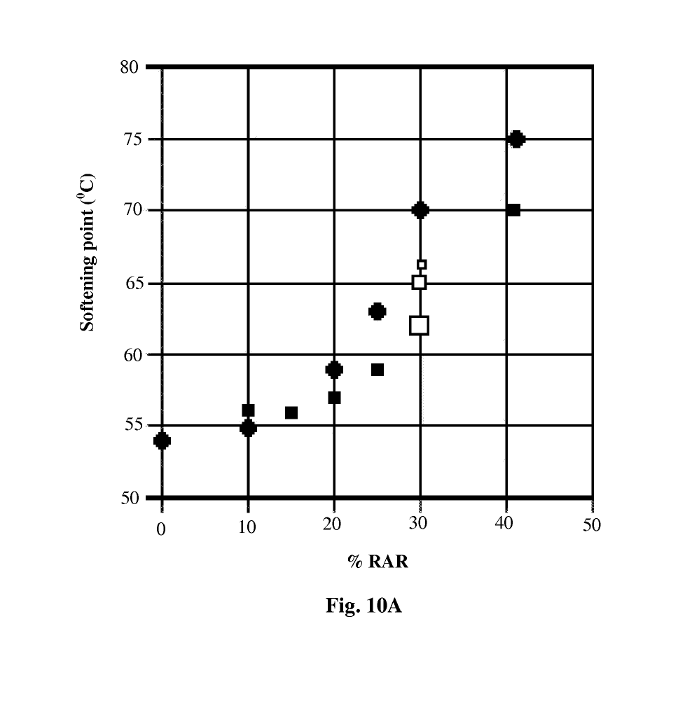

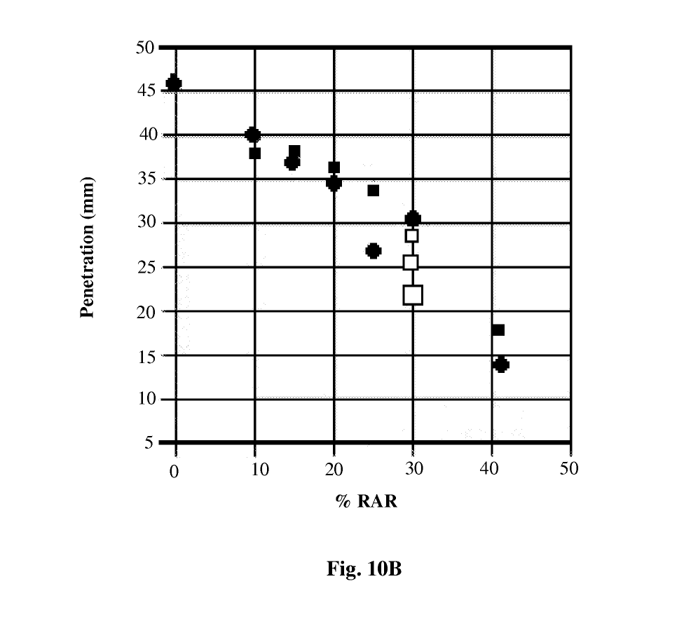

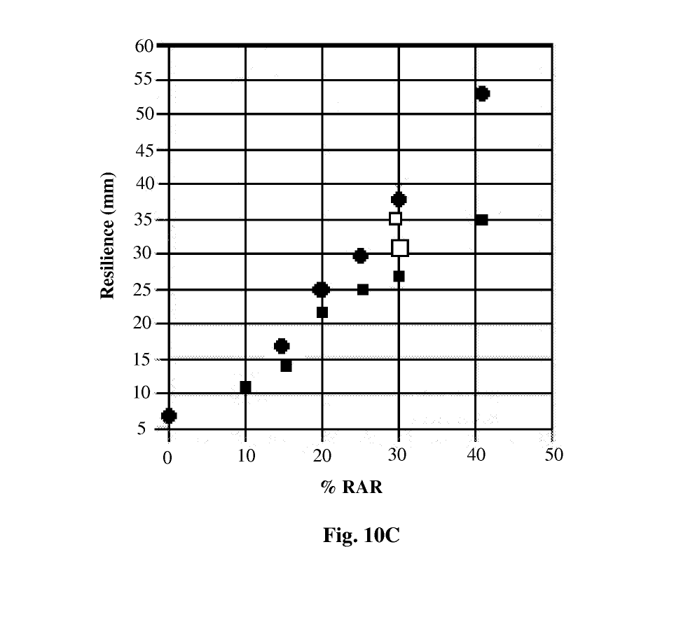

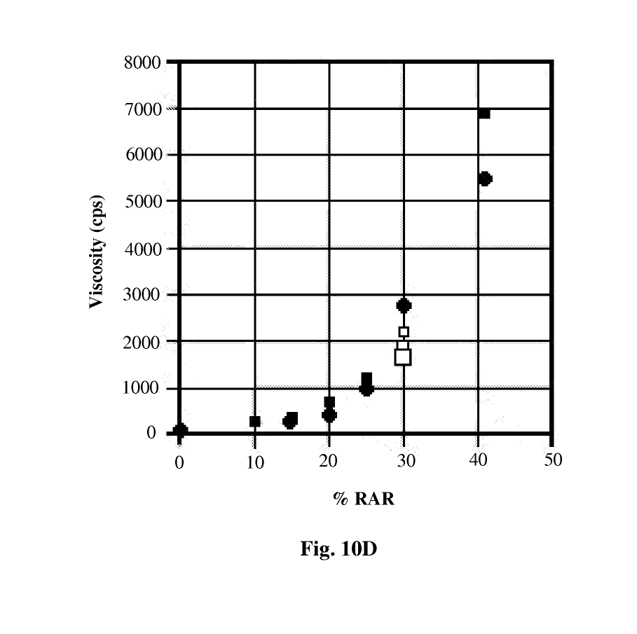

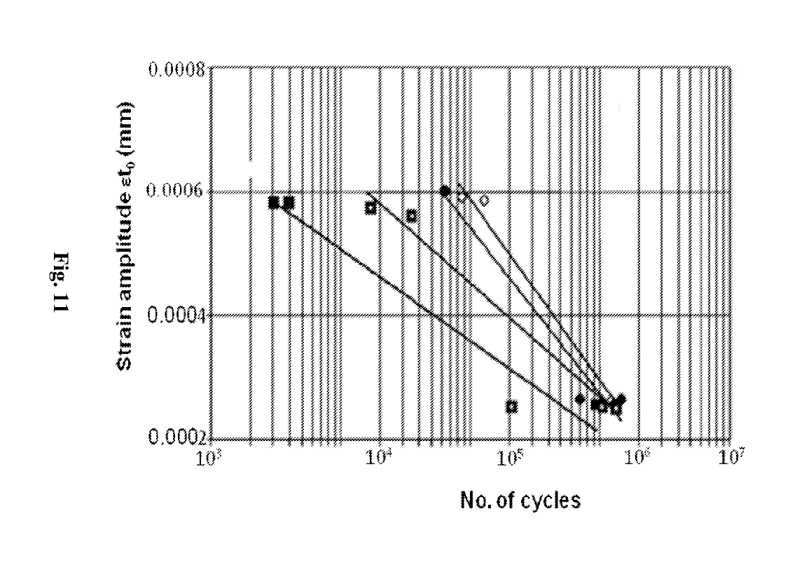

Several characteristics of the paving compositions were evaluated for different contents of RAR-composite, as shown in FIGS. 10A-10D.

Softening point is defined as the temperature in which a specimen of paving composition can no longer support the weight of a 3.5 g steel ball (ASTM D36). It is evident from the results (FIG. 10A), that the RAR-composites of the invention increase the softening point of the paving compositions, indicating a significant improvement in resistance to static load at high temperatures.

The complementary test of penetration (ASTM D5), conducted at a constant temperature of 25° C., measures the resistance of the pavement to penetration of a needle loaded with 100 g load for 5 seconds. The pavement specimens tested (FIG. 10B) demonstrate increased resistance to penetration with the increase in RAR-composite content.

Resilience of paving compositions comprising different amounts of RAR-composite of the invention was measured during the ITS tests using recoverable horizontal and vertical deformation that occurred during the unloading portion of the load-unload cycle. The resilience value may be regarded as a comparable characteristic of the elasticity of pavement composition. An increase in the RAR-composite content in the pavement composition results in improved resilience, and hence increased elasticity of the pavement (FIG. 10C).

Finally, the shear viscosity of the pavement compositions was measured in a plate and plate configuration using a dynamic rheometer at a constant oscillation angle (AASHTO TP5), estimating the ability of the pavement to withstand shear-mode stresses. As can be seen in FIG. 10D, the shear viscosity is increased dramatically with the content of RAR-composite, indicating an expected increased resistivity to shear loads.

TABLE 2
Marshall Test results

| | | | | | | Water | | |
|---|---|---|---|---|---|---|---|---|
| | | | | | | damage | | |
| | | | | | Average | resistance (% | | Average |
| | Duration of | | Height | Strength | strength | compression | Deformation | deformation |
| | test (hours) | Sample | (mm) | (N) | (N) | strength) | (mm) | (mm) |
| Reacted and | 1 | RAR-1 | 66 | 7,815 | 7,944 | 95.6 | 2.7 | 3.2 |
| activated rubber | | RAR-1 | 69 | 6,566 | | | 2.7 | |
| (Comp-3 based) | | RAR-1 | 67 | 9,452 | | | 4.3 | |
| | 24 | RAR-24 | 66 | 7,566 | 7,595 | | 5.5 | 5.5 |
| | | RAR-24 | 67 | 7,441 | | | 5.5 | |
| | | RAR-24 | 67 | 7,778 | | | 5.5 | |
| SMA-0.4% SiO₂ | 1 | SiO₂-1 | 64 | 8,401 | 8,039 | 101.2 | 2.7 | 2.7 |
| | | SiO₂-1 | 66 | 7,936 | | | 2.7 | |
| | | SiO₂-1 | 64 | 7,779 | | | 2.7 | |
| | 24 | SiO₂-24 | 63 | 8,405 | 8,139 | | 4.4 | 4.9 |
| | | SiO₂-24 | 62 | 8,600 | | | 5.5 | |
| | | SiO₂-24 | 62 | 7,412 | | | 4.7 | |
| SMA-0.4% Fibers | 1 | Fibers-1 | 60 | 9,446 | 9,920 | 104.2 | 2.6 | 2.6 |
| | | Fibers-1 | 59 | 10,830 | | | 1.8 | |
| | | Fibers-1 | 59 | 9,485 | | | 3.5 | |
| | 24 | Fibers-24 | 60 | 9,282 | 10,337 | | 3.5 | 3.5 |
| | | Fibers-24 | 63 | 9,919 | | | 3.5 | |
| | | Fibers-24 | 57 | 11,811 | | | 3.5 | |

TABLE 3
Wheel tracking test results

| | | | | Bulk | | | | | Deformation | | | | |
|---|---|---|---|---|---|---|---|---|---|---|---|---|---|
| | | | Bulk | theor. | | Average deformation | | | (rutting mm) | | | Permanent | |
| | | | density | Density | Porosity | speed (10⁻³ mm/min) | | | 120 | After | At 60° C. | deformation | Recovery |
| Slab | | | (g/cm³) | (g/cm³) | (Vol %) | V35/46 | V75/91 | V105/120 | min. | test | (hours) | % | % |
| 1 | Reacted | Comp- | 2.314 | 2.418 | 4.3 | 7.5 | 6.0 | 5.5 | 1.17 | 4 | 3 | 75 | 25 |
| | and | 3 | | | | | | | | | (37) | | |
| 2 | activated | based | 2.324 | | 3.9 | | | | 1.30 | 3 | 2 | 67 | 33 |
| | rubber | | | | | | | | | | (37) | | |
| 3 | | | 2.305 | | 4.7 | 12.8 | 6.5 | 5.8 | 2.58 | 5 | 5 | 100 | 0 |
| | | | | | | | | | | | (24) | | |
| 4 | | | 2.282 | | 5.6 | | | | 1.77 | 5 | 4 | 80 | 20 |
| | | | | | | | | | | | (24) | | |
| 5 | Asphalt | 18% | 2.253 | 2.401 | 6.2 | 19.0 | 9.8 | 8.2 | 3.06 | 5 | 5 | 100 | 0 |
| | rubber | rubber | | | | | | | | | (24) | | |
| 6 | | | 2.245 | | 6.5 | | | | 4.39 | 6 | 6 | 100 | 0 |
| | | | | | | | | | | | (24) | | |
| 7 | SMA-0.4% | 5.2% | 2.362 | 2.534 | 6.8 | 17.0 | 14.0 | 11.3 | 3.07 | NA | NA | NA | NA |
| 8 | SiO₂ | bitum. | 2.350 | | 7.2 | | | | 2.12 | NA | NA | NA | NA |
| 9 | SMA-0.4% | 6.4% | 2.346 | 2.525 | 7.1 | 10.0 | 7.5 | 6.8 | 3.46 | NA | NA | NA | NA |
| 10 | Fibers | bitum. | 2.359 | | 6.6 | | | | 2.72 | NA | NA | NA | NA |

TABLE 4
Cantabro test results

| | | | ITS (kPa) | | | Cantabro test (% weight loss) | | | |
|---|---|---|---|---|---|---|---|---|---|
| Paving mixture | | | Dry | Wet | TSR | Dry | Average | Wet | Average |
| 1 | Reacted and | Comp-3 | 932 | 980 | 84.1% | 12.6% | 13.9% | 18.6% | 15.3% |
| 2 | activated rubber | | 716 | 908 | | 14.7% | | 13.7% | |
| 3 | | | 705 | 910 | | 14.3% | | 13.7% | |
| 4 | SMA-0.4% | 5.2% bitumen | 1038 | 818 | 69.4% | 32.4% | 35.3% | 52.6% | 50.9% |
| 5 | SiO₂ | | 1340 | 737 | | 36.5% | | 47.2% | |
| 6 | | | 1027 | 807 | | 36.9% | | 52.7% | |
| 7 | SMA-0.4% | 6.4% bitumen | 1437 | 1428 | 79.6% | 16.3% | 15.6% | 16.0% | 16.4% |
| 8 | Fibers | | 1441 | 1362 | | 15.3% | | 17.0% | |
| 9 | | | 1417 | 1403 | | 15.2% | | 16.2% | |

### 3.3 Fatigue Tests

Four point bending fatigue tests were used to evaluate the behavior of paving compositions comprising RAR over time and consecutive loading conditions, in comparison with standard used compositions. Beam-shaped pavement specimens were subjected to sinusoidal-oscillating 4-points bending conditions under constant load, while sweeping across a range of strain amplitudes. The failure of a specimen is usually defined according to the number of oscillation cycles, typically at the 50% level of initial stiffness of the specimen. In all specimens tested, air voids constituted 4-5% vol.

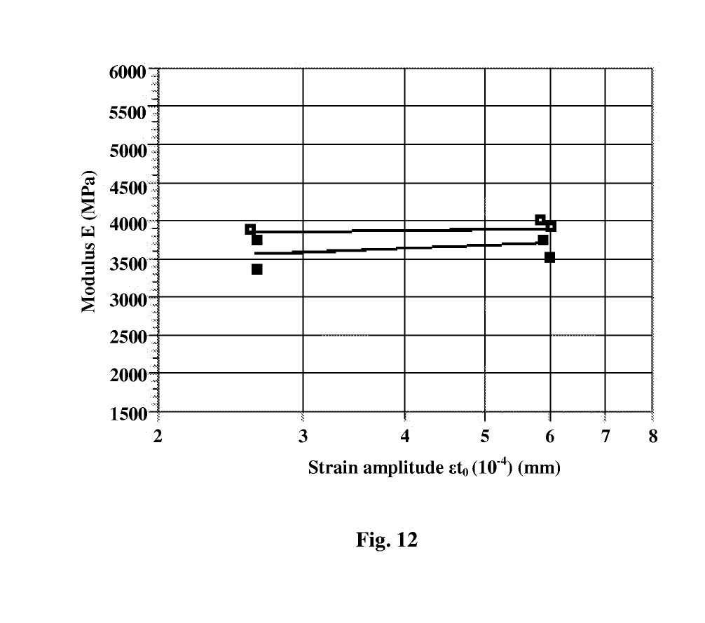

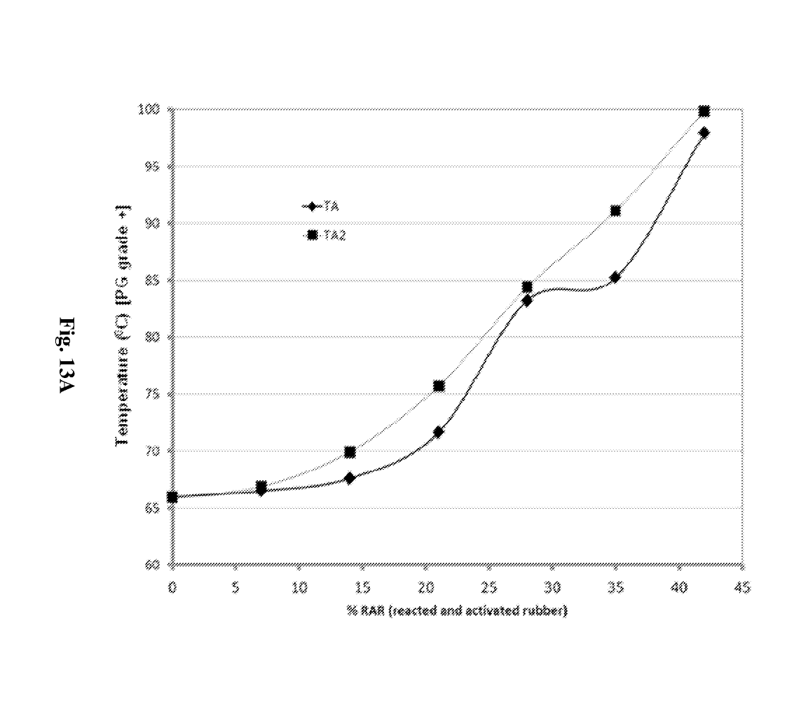

As can be seen in FIG. 11, the paving compositions containing RAR show significantly better fatigue resistance (failing after a larger number of cycles) than compositions comprising SMA with cellulose fibers or silica. The results shown in FIG. 12 further support these results, as no apparent change is observed in the elasticity modulus (indicating stiffness) of compositions containing the RAR composite over a relatively large range of strain amplitudes. This is a surprising result, as paving compositions are typically described as viscoelastic materials; hence their elastic/stiffness modulus is usually expected to decrease with an increase of load cycles.

### 4. Performance Grading

To demonstrate the superiority of paving compositions comprising the RAR-composite of the invention, tests were conducted according the recently developed Performance Grade methodology introduced during the SHRP (Strategic Highway Research Program) on 1993, now widely accepted as a new emerging standard. The PG gradation system is based on classification of paving compositions by two values (unlike the single value grading which is presently acceptable), being an indicator of the range of temperatures in which the paving composition is expected to maintain its properties. These two values (referred to as the “PG grade”) correspond to the binder's high temperature performance and low temperature performance, respectively, thereby providing a type of “plasticity” range for the binder.

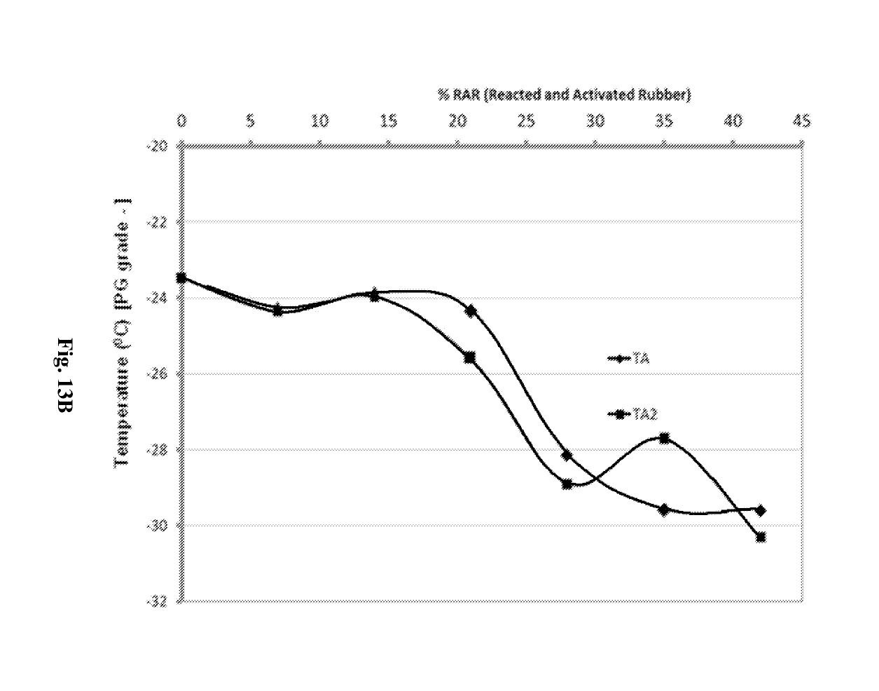

As can be seen from FIGS. 13A-13B, paving compositions comprising the RAR-composites of the invention show remarkable PG grade both at high temperatures (over 65° C.) and at low temperatures (below −22° C.). It is evident that increase in the RAR-composite content in the pavement results in a significant improvement in the PG grade. Of note is the result that even at low contents of RAR-composite (e.g. ˜7% wt), the pavements show a PG grade that is superior to those commonly acceptable in the industry, namely a high temperature of more than 58° C. and a low temperature below −16° C.

### 5. Pelletized Compositions

As already mentioned above, the composite of the invention may be formed into pellets, having increased stability in various storage conditions. In order to produce the pellets, bitumen was heated to 170° C. until a bitumen melt was obtained. The bitumen melt was then formed into droplets of about 0.5-3 grams each, mixed into particles of RAR-composite of approximately 1 mm in diameter, and allowed to cool, thus forming pellets having a bitumen core and a RAR-composite encapsulating layer. The RAR-composite constituted about 25% of the total weight of the pellet.

Subsequently, surface-activated silica powder was added onto the surface of the pellets in an excess amount of 10% (i.e. in addition to the surface-activated silica additive already present in the RAR-composite).

The pellets were then placed in a glass tube and the volume of the sample was measured. The tubes were maintained at different temperatures to mimic long-term storage conditions in the bulk, after which the volume of the samples was measured again. The stability test results are detailed in Table 5.

TABLE 5
stability test results of pelletized composites

| Sample | | Stability test conditions | | |
|---|---|---|---|---|
| Encapsulating | Coating | Temp. | Time | Total decrease |
| layer | layer | (° C.) | (min.) | volume |
| RAR-1 | — | 25 | 0 | 0 |
| | | | 15 | 18.5% |
| | | | 40 | 22.2% |
| | | | 60 | 25% |
| RAR-1 | — | 40 | 0 | 0 |
| | | | 10 | 25.9 % |
| | | | 30 | 37% |
| | | | 45 | 39.8% |
| | | | 60 | 40.7% |
| | | | 120 | 41.6% |
| RAR-1 | 10% surface- | 30 | 60 | 20% |
| | activated | | 1020 | 28% |
| | silica | | 1440 | 28% |
| RAR-1 | 10% surface- | 40 | 60 | 40% |
| | activated | | 1020 | 44% |
| | silica | | 1440 | 48% |
| RAR-1 | 10% surface- | 50 | 60 | 44% |
| | activated | | 1020 | 40% |
| | silica | | 1440 | 44% |

It is evident from the results, that the addition of about 10% surface-activated silica additive improves the pellets' stability at different storage conditions. The most significant result was obtained for the sample stored for 24 hours at 30° C., for which relatively low compaction was obtained. In addition, this sample was readily pourable after storage, indicating no adhesion occurred between the pellets. This is also an indirect indication that the surface of the pellets was indeed bitumen-free (i.e. oil dry).

1-80. (canceled)

81. A rubber composite, comprising:
rubber having an internal structure and an external surface; and
a heavy-fraction oil distillate,
wherein said heavy-fraction oil distillate is substantially contained within the internal structure, and the rubber external surface is substantially oil-free.

82. The rubber composite of claim 81, wherein the rubber is a particulate vulcanized rubber.

83. The rubber composite of claim 81, wherein the heavy-fraction oil distillate is bitumen.

84. The rubber composite of claim 81, wherein the composite is in a form selected from a particle, a flake, a sheet, a crumb, a grain, a pellet, and a granule.

85. The rubber composite of claim 81, wherein the composite comprises at least 15 wt % of the heavy-fraction oil distillate.

86. The rubber composite of claim 81, further comprising at least one additive.

87. The rubber composite of claim 86, wherein the at least one additive either (i) is contained within the internal structure of the rubber composite, (ii) is present at the external surface of the rubber composite, or (iii) is both contained within the internal structure of the rubber composite and is present at the external surface of the rubber composite.

88. The rubber composite of claim 86, wherein said at least one additive is a mineral-based powder selected from silica, surface-activated silica, mica, porcelanite, other silica or amorphous silica containing material, lime, and cement.

89. The rubber composite of claim 86, comprising at least 1 wt % of said at least one additive.

90. A composition, comprising:
a bitumen core; and
an encapsulation layer comprising the rubber composite of claim 1, wherein the rubber composite at least partially encapsulates the bitumen core, and an external surface of the composition is substantially oil-free.

91. The composition of claim 90, further comprising a layer of at least one powdered additive, said layer at least partially coating the external surface of the composition.

92. The composition of claim 90, wherein said rubber composite substantially fully encapsulates the bitumen core.

93. The composition of claim 90, wherein the composition is in a form selected from a particle, a flake, a sheet, a crumb, a grain, a pellet, and a granule.

94. The composition of claim 90, further comprising:
a paving binder; and
an aggregate;
wherein said composition exhibits dimensional regaining of at least 10% within 24 hours after unloading under Marshall test conditions.

95. A process for obtaining a modified rubber composite, the process comprising the steps of:
a. providing particulate rubber;
b. providing a heavy-fraction oil distillate optionally comprising at least one additive; and
c. mixing the particulate rubber and the heavy-fraction oil distillate under conditions permitting a reaction to develop exothermally, to thereby obtain a particulate dry modified rubber composite in which the heavy-fraction oil distillate is substantially contained within an internal structure of the particulate rubber.

96. The process of claim 95, wherein the particulate rubber is particulate vulcanized rubber.

97. The process of claim 95, wherein said conditions include at least one of (i) mixing at a temperature of between about 120° C. and 260° C., and (ii) said mixing is carried out for a period of time of at least 10 seconds.

98. The process of claim 95, further comprising at least one of (i) a step (d) of grinding said modified rubber composite to reduce the particles to a desired size, and (ii) a step (d′) of adding at least one additive at an amount of at least 1 wt %.

99. The process of claim 95, wherein the modified rubber composite comprises at least 15 wt % of heavy-fraction oil distillate.
